(19) United States
(12) Patent Application Publication
(10) Pub. No.: US 2025/0197605 A1
(43) Pub. Date: Jun. 19, 2025

(54) PLASTICIZER COMPOSITION FOR CELLULOSE ESTER RESIN, CELLULOSE ESTER RESIN COMPOSITION, AND MOLDED PRODUCT THEREOF

(71) Applicant: DIC Corporation, Tokyo (JP)

(72) Inventors: Tomoyo Ozaki, Ichihara-shi (JP); Yusuke Tajiri, Ichihara-shi (JP); Takafumi Noguchi, Ichihara-shi (JP)

(73) Assignee: DIC Corporation, Tokyo (JP)

(21) Appl. No.: 18/946,327

(22) Filed: Nov. 13, 2024

(30) Foreign Application Priority Data
Dec. 19, 2023 (JP) 2023-213690

(51) Int. Cl. C08L 1/12; C08K 5/103; C08K 5/11; G02C 5/00

(52) U.S. Cl. CPC C08L 1/12; C08K 5/103; C08K 5/11; G02C 5/008; C08K 2201/014; C08L 2205/06

(57) ABSTRACT

A plasticizer composition for a cellulose ester resin, includes an alkoxy ether diester compound represented by General Formula (A) and a benzoic acid ester compound represented by General Formula (B)

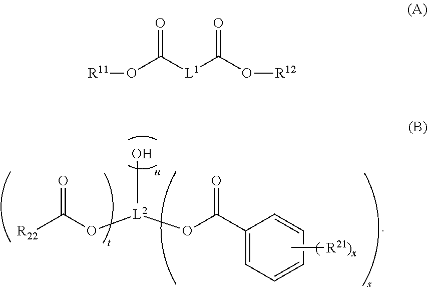

### BACKGROUND OF THE INVENTION

### 1. Field of the Invention

The present invention relates to a plasticizer composition for a cellulose ester resin, a cellulose ester resin composition, and a molded article thereof.

### 2. Description of the Related Art

General purpose plastics, such as a polyvinyl chloride (PVC) resin, have been used for a wide range of applications and plasticizers are usually added to such general purpose plastics to make the plasticizers flexible for use. However, general purpose plastics are difficult to degrade, and thus there has been a recent movement to switch from general purpose plastics to biodegradable resins from the viewpoint of emphasizing “sustainability”.

Since biodegradable resins usually have a polarity higher than that of the general purpose plastics, there is a demand for plasticizers suitable for biodegradable resins, which are different from the general purpose plastics of the related art. Among the biodegradable resins, a cellulose ester resin has been attracting attention in terms of the applications thereof as a bio-derived sustainable material, and alkoxy ether diester is known as a plasticizer of the cellulose ester resin (Japanese Unexamined Patent Application Publication No. 2007-77300).

The alkoxy ether diester has a high performance as a plasticizer of a cellulose ester resin, but the alkoxy ether diester has a property of being easily hydrolyzed. In a cellulose ester resin composition containing the alkoxy ether diester as a plasticizer, the cellulose ester resin is also hydrolyzed due to an acid generated by the hydrolysis of the alkoxy ether diester, which causes a disadvantage of degradation of dimension stability and durability of a molded article to be obtained.

### SUMMARY OF THE INVENTION

An object of the present invention to be achieved is to provide a plasticizer composition for a cellulose ester resin with improved hydrolysis resistance.

Another object of the present invention to be achieved is to provide a molded article with excellent dimension stability and excellent durability.

As a result of intensive examination conducted by the present inventors in order to achieve the above-described objects, it has been found that hydrolysis resistance of a plasticizer can be improved by further using a benzoic acid ester compound together with alkoxy ether diester, thereby completing the present invention.

That is, the present invention relates to a plasticizer composition for a cellulose ester resin and the like.

1. A plasticizer composition for a cellulose ester resin, including: an alkoxy ether diester compound represented by General Formula (A); and a benzoic acid ester compound represented by General Formula (B),

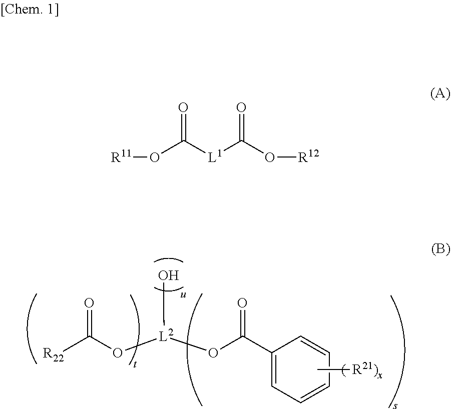

(in General Formulae (A) and (B),
L¹ represents an alkylene group having 1 to 18 carbon atoms,
R¹¹ and R¹² each independently represent an alkyl group having an ether bond with 2 to 24 carbon atoms,
R²¹ represents an alkyl group having 1 to 6 carbon atoms,
L² represents a divalent aliphatic group or a trivalent aliphatic group,
R²² represents an alkyl group having 1 to 20 carbon atoms or an alkyl group having an ether bond with 2 to 20 carbon atoms,
s represents an integer of 1 to 3, t represents an integer of 0 to 2, u represents an integer of 0 to 2, and a sum of s, t, and u is an integer corresponding to the valence of the aliphatic group as L², and
x represents an integer of 0 to 5).

2. The plasticizer composition for a cellulose ester resin according to 1, in which a mass ratio of the alkoxy ether diester compound to the benzoic acid ester compound (alkoxy ether diester compound:benzoic acid ester compound) is in a range of 85:15 to 40:60.

3. The plasticizer composition for a cellulose ester resin according to 1 or 2, in which the alkoxy ether diester compound is an alkoxy ether diester compound represented by General Formula (A1),

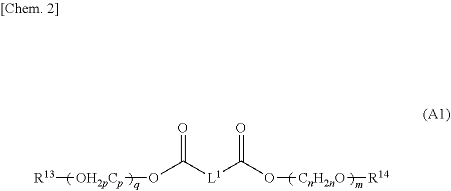

(in General Formula (A1),
L¹ represents an alkylene group having 1 to 18 carbon atoms,
n represents an integer of 1 to 4,
m represents an integer of 2 to 4,
p represents an integer of 1 to 4,
q represents an integer of 2 to 4,
R¹³ and R¹⁴ each independently represent an alkyl group having 1 to 6 carbon atoms,
m number of n's may be the same as or different from each other, and q number of p's may be the same as or different from each other).

4. The plasticizer composition for a cellulose ester resin according to any one of 1 to 3, in which L¹ represents a malonic acid residue, a succinic acid residue, a glutaric acid residue, an adipic acid residue, a pimelic acid residue, a suberic acid residue, an azelaic acid residue, a sebacic acid residue, a dodecanedicarboxylic acid residue, a maleic acid residue, a fumaric acid residue, a 1,2-dicarboxycyclohexane residue, or a 1,2-dicarboxycyclohexene residue.

5. The plasticizer composition for a cellulose ester resin according to any one of 1 to 4, in which R¹¹ and R¹² each independently represent an alcohol residue of polyalkylene glycol monoalkyl ether selected from diethylene glycol monomethyl ether, diethylene glycol monoethyl ether, triethylene glycol monomethyl ether, triethylene glycol monoethyl ether, tetraethylene glycol monomethyl ether, and tetraethylene glycol monoethyl ether.

6. The plasticizer composition for a cellulose ester resin according to any one of 1 to 5, in which the benzoic acid ester compound is a benzoic acid ester compound represented by General Formula (B1),

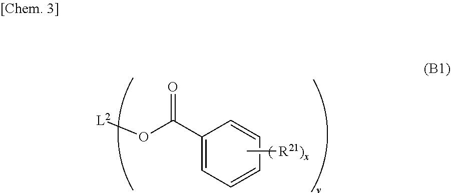

(in General Formula (B1),
L² represents a divalent aliphatic group or a trivalent aliphatic group,
v represents an integer corresponding to the valence of the aliphatic group as L²,
R²¹ represents an alkyl group having 1 to 6 carbon atoms, and
x represents an integer of 0 to 5).

7. The plasticizer composition for a cellulose ester resin according to any one of 1 to 6, in which L² represents an ethylene glycol residue, a 1,2-propylene glycol residue, a 1,3-propanediol residue, a 1,2-butanediol residue, a 1,3-butanediol residue, a 2-methyl-1,3-propanediol residue, a neopentyl glycol residue, a diethylene glycol residue, a dipropylene glycol residue, a triethylene glycol residue, a tripropylene glycol residue, a trimethylolpropane residue, or a glycerin residue.

8. A cellulose ester resin composition including: the plasticizer composition for a cellulose ester resin according to any one of 1 to 7; and a cellulose ester resin, in which a content of the plasticizer composition for a cellulose ester resin is in a range of 1 to 100 parts by mass with respect to 100 parts by mass of the cellulose ester resin.

9. A molded article of the cellulose ester resin composition according to 8.

10. The molded article according to 9, in which the molded article is an eyeglass frame.

According to the present invention, it is possible to provide a plasticizer composition for a cellulose ester resin with improved hydrolysis resistance.

According to the present invention, it is possible to provide a molded article with excellent dimension stability and excellent durability.

### DESCRIPTION OF THE PREFERRED EMBODIMENTS

Hereinafter, an embodiment of the present invention will be described. The present invention is not limited to the following embodiment and can be implemented by appropriately adding modifications within a range where the effects of the present invention are not impaired.

Further, compounds in the present specification may be derived from fossil resources or biological resources.

### [Plasticizer Composition for Cellulose Ester Resin]

A plasticizer composition for a cellulose ester resin according to the present invention (hereinafter, also simply referred to as “plasticizer composition of the present invention”) contains an alkoxy ether diester compound represented by General Formula (A) and a benzoic acid ester compound represented by General Formula (B).

Hereinafter, each component of the plasticizer composition of the present invention will be described.

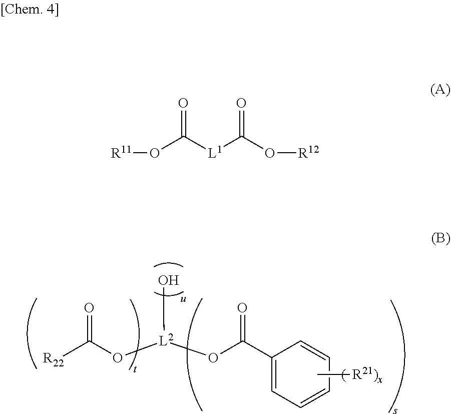

(In General Formulae (A) and (B),
L¹ represents an alkylene group having 1 to 18 carbon atoms,
R¹¹ and R¹² each independently represent an alkyl group having an ether bond with 2 to 24 carbon atoms,
R²¹'s each independently represent an alkyl group having 1 to 6 carbon atoms,
L² represents a divalent aliphatic group or a trivalent aliphatic group,
R²² represents an alkyl group having 1 to 20 carbon atoms or an alkyl group having an ether bond with 2 to 20 carbon atoms,
s represents an integer of 1 to 3, t represents an integer of 0 to 2, u represents an integer of 0 to 2, and the sum of s, t, and u is an integer corresponding to the valence of the aliphatic group as L², and
x represents an integer of 0 to 5.)

### (Alkoxy Ether Diester Compound)

The alkoxy ether diester compound represented by General Formula (A) is, for example, a compound obtained by reacting aliphatic dibasic acid with alkyl alcohol having an ether bond.

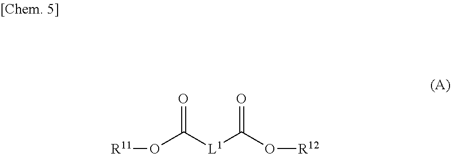

(In General Formula (A),
L¹ represents an alkylene group having 1 to 18 carbon atoms, and
R¹¹ and R¹² each independently represent an alkyl group having an ether bond with 2 to 24 carbon atoms.)

The alkylene group having 1 to 18 carbon atoms as L¹ may be linear or branched. Further, the alkylene group having 1 to 18 carbon atoms as L¹ may have an alicyclic structure.

Specific examples of the alkylene group having 1 to 18 carbon atoms as L¹ include a malonic acid residue, a succinic acid residue, a glutaric acid residue, an adipic acid residue, a pimelic acid residue, a suberic acid residue, an azelaic acid residue, a sebacic acid residue, a dodecanedicarboxylic acid residue, a maleic acid residue, a fumaric acid residue, a 1,2-dicarboxycyclohexane residue, and a 1,2-dicarboxycyclohexene residue. Among these, a succinic acid residue, a glutaric acid residue, an adipic acid residue, or a sebacic acid residue is preferable, and a succinic acid residue or an adipic acid residue is more preferable.

Further, in the present invention, the term “carboxylic acid residue” denotes an organic group that remains after removing a carboxyl group from a carboxylic acid. The number of carbon atoms in the carboxylic acid residue does not include the carbon atoms in the carboxyl group.

The alkyl group having an ether bond with 2 to 24 carbon atoms as R¹¹ and R¹² may be linear or branched. Further, the alkyl group having an ether bond with 2 to 24 carbon atoms as R¹¹ and R¹² may have an alicyclic structure.

Specific examples of the alkyl group having an ether bond with 2 to 24 carbon atoms as R¹¹ and R¹² include an alcohol residue of polyalkylene glycol monoalkyl ether such as diethylene glycol monomethyl ether, diethylene glycol monoethyl ether, triethylene glycol monomethyl ether, triethylene glycol monoethyl ether, tetraethylene glycol monomethyl ether, or tetraethylene glycol monoethyl ether. Among these, an alcohol residue of diethylene glycol monomethyl ether or an alcohol residue of triethylene glycol monomethyl ether is preferable.

Further, the term “alcohol residue” in the present invention denotes an organic group that remains after removing a hydroxyl group from an alcohol.

It is preferable that the alkoxy ether diester compound represented by General Formula (A) be an alkoxy ether diester compound represented by General Formula (A1).

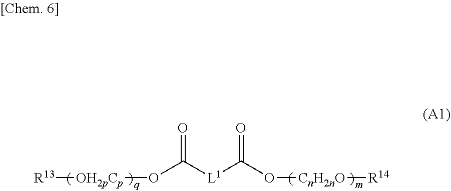

(In General Formula (A1),
L¹ represents an alkylene group having 1 to 18 carbon atoms,
n represents an integer of 1 to 4 and preferably an integer of 2 or 3,
m represents an integer of 2 to 4 and preferably an integer of 2 or 3,
p represents an integer of 1 to 4 and preferably an integer of 2 or 3,
q represents an integer of 2 to 4 and preferably an integer of 2 or 3,
R¹³ and R¹⁴ each independently represent an alkyl group having 1 to 6 carbon atoms,
m number of n's may be the same as or different from each other, and q number of p's may be the same as or different from each other.)

The alkyl group having 1 to 6 carbon atoms as R¹³ and R¹⁴ is preferably an alkyl group having 1 or 2 carbon atoms and more preferably a methyl group.

The alkoxy ether diester compound represented by General Formula (A) in the plasticizer composition of the present invention may be used alone or in combination of two or more kinds thereof.

The alkoxy ether diester compound is, for example, a compound obtained by reacting aliphatic dibasic acid with alkyl alcohol having an ether bond as described above, and can be produced by a known method.

### (Benzoic Acid Ester Compound)

The benzoic acid ester compound represented by General Formula (B) is, for example, a compound obtained by reacting an aliphatic diol or an aliphatic triol, a benzoic acid derivative, and any aliphatic monocarboxylic acid. Since the plasticizer composition contains benzoic acid ester, the influence of water on the alkoxy ether diester can be reduced, and the defect of the alkoxy ether diester that is easily hydrolyzed can be complemented.

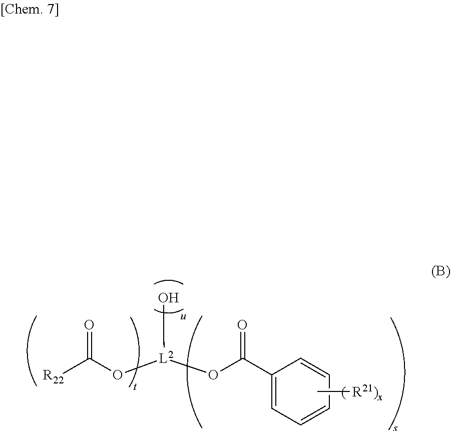

(In General Formula (B),
R²¹ represents an alkyl group having 1 to 6 carbon atoms,
L² represents a divalent aliphatic group or a trivalent aliphatic group,
R²² represents an alkyl group having 1 to 20 carbon atoms or an alkyl group having an ether bond with 2 to 20 carbon atoms,
s represents an integer of 1 to 3, t represents an integer of 0 to 2, u represents an integer of 0 to 2, and the sum of s, t, and u is an integer corresponding to the valence of the aliphatic group as L², and
x represents an integer of 0 to 5.)

In General Formula (B), “s+t+u=2” is satisfied in a case where L² represents a divalent aliphatic group, and “s+t+u=3” is satisfied in a case where L² represents a trivalent aliphatic group.

In General Formula (B), in a case where a plurality of R²¹'s are present, the plurality of R²¹'s may be the same as or different from each other. Similarly, in General Formula (B), in a case where a plurality of R²²'s are present, the plurality of R²²'s may be the same as or different from each other.

When L² represents a divalent aliphatic group, examples of the divalent aliphatic group include an alkylene group having 1 to 12 carbon atoms and an alkylene group having an ether bond with 1 to 12 carbon atoms.

Specific examples of the alkylene group having 1 to 12 carbon atoms as L² include an ethylene glycol residue, a 1,2-propylene glycol residue, a 1,3-propanediol residue, a 1,2-butanediol residue, a 1,3-butanediol residue, a 2-methyl-1,3-propanediol residue, a 1,4-butanediol residue, a 1,5-pentanediol residue, a 2,2-dimethyl-1,3-propanediol (neopentyl glycol) residue, a 2,2-diethyl-1,3-propanediol (3,3-dimethylolpentane) residue, a 2-n-butyl-2-ethyl-1,3-propanediol (3,3-dimethylolheptane) residue, a 3-methyl-1,5-pentanediol residue, a 1,6-hexanediol residue, a 2,2,4-trimethyl-1,3-pentanediol residue, a 2-ethyl-1,3-hexanediol residue, a 2-methyl-1,8-octanediol residue, a 1,9-nonanediol residue, a 1,10-decanediol residue, and a 1,12-dodecanediol residue.

Further, in the present invention, the term “alcohol residue” and the term “glycol residue” each denote an organic group that remains after removing a hydroxyl group from an alcohol and glycol.

The alkylene group having 1 to 12 carbon atoms as L² may have an alicyclic structure, and examples of the alkylene group having 1 to 12 carbon atoms, which has an alicyclic structure, include a 1,3-cyclopentanediol residue, a 1,2-cyclohexanediol residue, a 1,3-cyclohexanediol residue, a 1,4-cyclohexanediol residue, a 1,2-cyclohexanedimethanol residue, and a 1,4-cyclohexanedimethanol residue.

The alkylene group having 1 to 12 carbon atoms as L² is preferably an alkylene group having 1 to 10 carbon atoms and more preferably an alkylene group having 1 to 6 carbon atoms.

The alkylene group having an ether bond with 1 to 12 carbon atoms as L² is a group in which one or more of (—CH₂—)'s among the examples of the alkylene group are substituted with —O—.

The alkylene group having an ether bond with 1 to 12 carbon atoms as L² is preferably an alkylene group having an ether bond with 1 to 10 carbon atoms and more preferably an alkylene group having an ether bond with 1 to 8 carbon atoms.

Specific examples of the alkylene group having an ether bond with 1 to 12 carbon atoms as L² include a diethylene glycol residue, a triethylene glycol residue, a tetraethylene glycol residue, a dipropylene glycol residue, and a tripropylene glycol residue.

In a case where L² represents a trivalent aliphatic group, examples of the trivalent aliphatic group include the alkylene group having 1 to 12 carbon atoms and a group in which one of the hydrogen atoms bonded to the carbon atoms of the alkylene group having an ether bond with 2 to 12 carbon atoms is replaced with a bond.

Specific examples of the trivalent aliphatic group include a trimethylolpropane residue and a glycerin residue.

L² represents preferably an ethylene glycol residue, a 1,2-propylene glycol residue, a 1,3-propanediol residue, a 1,2-butanediol residue, a 1,3-butanediol residue, a 2-methyl-1,3-propanediol residue, a neopentyl glycol residue, a diethylene glycol residue, a dipropylene glycol residue, a triethylene glycol residue, a trimethylolpropane residue, or a glycerin residue, more preferably an ethylene glycol residue, a diethylene glycol residue, a 1,2-propylene glycol residue, a dipropylene glycol residue, a trimethylolpropane residue, or a glycerin residue, and still more preferably an ethylene glycol residue, a diethylene glycol residue, a 1,2-propylene glycol residue, or a dipropylene glycol residue.

X represents preferably 0 or 1 and more preferably 0.

It is preferable that the benzoic acid ester compound represented by General Formula (B) be a benzoic acid ester compound represented by General Formula (B1).

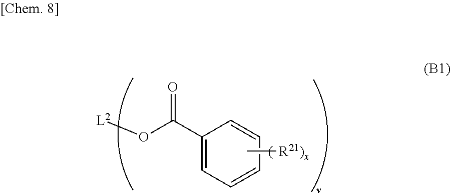

(In General Formula (B1),
L² represents a divalent aliphatic group or a trivalent aliphatic group,
v represents an integer corresponding to the valence of the aliphatic group as L²,
R²¹ represents an alkyl group having 1 to 6 carbon atoms, and
x represents an integer of 0 to 5.)

The benzoic acid ester compound represented by General Formula (B) in the plasticizer composition of the present invention may be used alone or in combination of two or more kinds thereof.

The benzoic acid ester compound is, for example, a compound obtained by reacting an aliphatic diol or an aliphatic triol, a benzoic acid derivative, and any aliphatic monocarboxylic acid as described above, and can be produced by a known method.

The mass ratio of the alkoxy ether diester compound to the benzoic acid ester compound (alkoxy ether diester compound:benzoic acid ester compound) in the plasticizer composition of the present invention is, for example, in a range of 90:10 to 20:80, preferably in a range of 85:15 to 40:60, and more preferably in a range of 80:20 to 50:50.

The plasticizer composition of the present invention may contain the alkoxy ether diester compound and the benzoic acid ester compound and may contain other plasticizer components within a range where the effects of the present invention are not impaired.

It is preferable that the plasticizer composition of the present invention be substantially formed of the alkoxy ether diester compound and the benzoic acid ester compound. Here, the expression “substantially formed of” denotes that the total amount of the alkoxy ether diester compound and the benzoic acid ester compound is 90% by mass or greater, 95% by mass or greater, 98% by mass or greater, or 100% by mass with respect to the amount of the plasticizer composition of the present invention.

### [Cellulose Ester Resin Composition]

The cellulose ester resin composition of the present invention contains the plasticizer composition of the present invention and a cellulose ester resin.

Examples of the cellulose ester resin contained in the cellulose ester resin composition of the present invention include cellulose acetate (CA), cellulose diacetate (DAC), cellulose triacetate (TAC), cellulose acetate propionate (CAP), cellulose acetate butyrate (CAB), cellulose acetate phthalate, and polycaprolactone-grafted cellulose acetate. Among these, from the viewpoint that the transparency, the processability, and the mechanical properties (tensile strength, bending strength, bending elasticity, and the like) are satisfactory, acetylated cellulose such as cellulose acetate, cellulose diacetate, cellulose triacetate, cellulose acetate propionate, or cellulose acetate butyrate is preferable, and cellulose diacetate is most preferable.

The cellulose ester resin can be used alone or in combination of two or more kinds thereof.

In a case where the cellulose ester resin is acetylated cellulose, the upper limit of the substitution degree of the acetyl group is preferably 3.0 or less, more preferably 2.7 or less, and still more preferably 2.6 or less. The lower limit of the substitution degree thereof is preferably 1.0 or greater, more preferably 1.5 or greater, and still more preferably 2.0 or greater.

In a case where the polymerization degree of the cellulose acetate is in the ranges described below and the substitution degree thereof is in the above-described ranges, a film having excellent mechanical properties can be obtained. In the present invention, it is more preferable to use so-called cellulose diacetate.

The polymerization degree of cellulose ester is preferably in a range of 100 to 1000 and more preferably in a range of 100 to 500 in terms of the viscosity average polymerization degree.

The above-described “viscosity average polymerization degree” can be measured in conformity with the intrinsic viscosity method by Uda et al. (Kazuo Uda, Hideo Saito, “Sen'i Gakkaishi”, Vol. 18, No. 1, pp. 105 to 120, 1962). Specifically, 0.2 g of bone-dried cellulose ester is precisely weighed and dissolved in 100 ml of a mixed solvent obtained by mixing methylene chloride and ethanol at a mass ratio of 9:1, the fall time of the solution is measured using an Ostwald viscometer in a constant-temperature water tank at a temperature of 25° C., and the average polymerization degree is calculated by [Equation 1].

$$Average polymerization degree = [ η ] / {K}_{m} \qquad [ Equation 1 ]$$

[η]=(lnηᵣₑ₁)/C
ηᵣₑₗ=T/T₀
Kₘ=6×10⁻⁴
T: Fall time (sec) of measurement sample
T₀: Fall time (sec) of solvent
C: concentration (g/l) of sample

A commercially available product may be used as the cellulose ester resin, and examples of the commercially available product include cellulose diacetate such as “L-20”, “L-30”, “L-40”, “L-50”, or “L-70” (all manufactured by Daicel Corporation), cellulose triacetate such as “LT-35” or “LT-105” (both manufactured by Daicel Corporation), and cellulose acetate propionate such as “CAP482-20” or “CAP141-20”, cellulose acetate butyrate such as “CAB381-20” or “CAB171-15”, and cellulose acetate such as “CA398-30” (all manufactured by Eastman Chemical Company).

From the viewpoints of the compatibility of the plasticizer composition with the cellulose ester resin and the like, the content of the plasticizer composition of the present invention in the cellulose ester resin composition of the present invention is preferably in a range of 1 to 100 parts by mass, more preferably in a range of 5 to 60 parts by mass, still more preferably in a range of 10 to 50 parts by mass, and even still more preferably in a range of 20 to 45 parts by mass with respect to 100 parts by mass of the cellulose ester resin.

The total content of the cellulose ester resin and the plasticizer composition of the present invention in the cellulose ester resin composition of the present invention is, for example, 80% by mass or greater, 90% by mass or greater, or 95% by mass or greater with respect to the solid content in the composition. The upper limit of the total content of the cellulose ester resin and the plasticizer composition of the present invention is not particularly limited, and is, for example, 100% by mass or less, 95% by mass or less, or 90% by mass or less.

The cellulose ester resin composition of the present invention may contain the cellulose ester resin and the plasticizer composition of the present invention, and may also contain other resins, plasticizers (other plasticizers) other than the plasticizer composition of the present invention, other additives, and the like.

The other resins are not particularly limited, and examples thereof include polyolefin, polysulfide, polyvinyl chloride, modified polysulfide, a silicone resin, a modified silicone resin, an acrylic urethane resin, an epoxy resin, polyurethane, an acrylic resin, polyester, and unsaturated polyester.

Examples of the other plasticizers include phthalic acid ester such as dimethyl phthalate (DMP), diethyl phthalate (DEP), dibutyl phthalate (DBP), di-2-ethylhexyl phthalate (DOP), diisononyl phthalate (DINP), diisodecyl phthalate (DIDP), diundecyl phthalate (DUP), or ditridecyl phthalate (DTDP); terephthalic acid ester such as dimethyl terephthalate (DMTP), diethyl terephthalate (DETP), or bis(2-ethylhexyl) terephthalate (DOTP); isophthalic acid ester such as dimethyl isophthalate (DMIP), diethyl isophthalate (DEIP), or bis(2-ethylhexyl) isophthalate (DOIP); trimellitic acid ester such as tributyl trimellitate (TBTM), tri-2-ethylhexyl trimellitate (TOTM), or tri-n-octyl trimellitate (TnOTM); pyromellitic acid ester such as tetra-2-ethylhexyl pyromellitate (TOPM); aliphatic dibasic acid ester such as di-2-ethylhexyl adipate (DOA), diisononyl adipate (DINA), diisodecyl adipate (DIDA), di-2-ethylhexyl sebacate (DOS), or diisononyl sebacate (DINS); phosphoric acid ester such as tri-2-ethylhexyl phosphate (TOP) or tricresyl phosphate (TCP); alkyl ester of polyhydric alcohol such as pentaerythritol; polyester having a molecular weight of 800 to 4000, which is synthesized by polyesterification of dibasic acid such as adipic acid with glycol; epoxidized ester such as epoxidized soybean oil or epoxidized linseed oil; alicyclic dibasic acid such as hexahydrophthalic acid diisononyl ester; fatty acid glycol ester such as 1,4-butanediol dicaprate; glycerin ester such as triacetin or diacetin; chlorinated paraffin obtained by chlorinating paraffin wax or n-paraffin; chlorinated fatty acid ester such as chlorinated stearic acid ester; and higher fatty acid ester such as butyl oleate.

In a case where the above-described other plasticizers are used in the cellulose ester resin composition of the present invention, the content of the other plasticizers is, for example, in a range of 0.1 to 100 parts by mass and preferably in a range of 1 to 50 parts by mass with respect to 100 parts by mass of the plasticizer composition of the present invention.

Examples of the other additives include a flame retardant, a stabilizer, a stabilizing assistant, a coloring agent, a processing assistant, a filler, an antioxidant (anti-aging agent), an ultraviolet absorbing agent, a light stabilizer, a lubricant, an antistatic agent, and a crosslinking assistant.

### [Method of Producing Cellulose Ester Resin Composition]

A method of producing the cellulose ester resin composition of the present invention is not limited.

For example, the cellulose ester resin composition can be obtained by a method of melting and kneading the cellulose ester resin, the plasticizer composition for a cellulose ester resin of the present invention, the other additives, and the like using a single-screw extruder, a twin-screw extruder, a Banbury mixer, a Brabender, various kneaders, and the like.

### [Molded Article of Cellulose Ester Resin Composition]

The cellulose ester resin composition of the present invention can be molded by various molding methods applied to general purpose plastics.

Examples of the molding method include compression molding (compression molding, lamination molding, or stampable molding), injection molding, extrusion molding or co-extrusion molding (film molding by an inflation method or a T-die method, laminate molding, pipe molding, wire/cable molding, or profile molding), 3D printing, heat-press molding, hollow molding (various types of blow molding), calendar molding, solid molding (uniaxial stretch molding, biaxial stretch molding, roll rolling molding, stretch-oriented nonwoven fabric molding, heat molding (vacuum molding or pressure molding), plastic processing, powder molding (rotational molding), and various types of nonwoven fabric molding (a dry method, an adhesion method, an entanglement method, a spunbond method, or the like).

Among these, injection molding, extrusion molding, 3D printing, compression molding, or heat-press molding is suitably applied. Specific preferred examples of the shape include a sheet, a film, and a shape that can be applied to a container.

The molded article obtained above may be subjected to secondary processing. Examples of the secondary processing include embossing, painting, adhesion, printing, metallizing (plating or the like), machining, and a surface treatment (an antistatic treatment, a corona discharge treatment, a plasma treatment, a photochromism treatment, physical vapor deposition, chemical vapor deposition, coating, or the like).

Since the molded article obtained from the cellulose ester resin composition of the present invention is formed of the cellulose ester resin and thus is degradable, the environmental load of the molded article is small.

The molded article obtained from the cellulose ester resin composition of the present invention is suitably used for a wide range of applications such as packaging materials for packing liquid materials, powder materials, and solids, agricultural materials, construction materials, and the like.

Specific examples of the applications thereof include injection molded articles (such as fresh food trays, fast food containers, coffee capsule containers, cutlery, and outdoor leisure products), extrusion molded articles (such as films, sheets, fishing lines, fishing nets, vegetation nets, sheets for secondary processing, and water-retaining sheets), hollow molded articles (bottles and the like), and shaping performed by 3D printing.

The applications thereof are not limited to the examples described above, and the molded article can also be used as mending tape, eyeglass frames, aglets, agricultural films, coating materials, coating materials for fertilizers, seedling pots, laminated films, boards, stretched sheets, monofilaments, nonwoven fabrics, flat yarns, staples, crimpled fibers, striped tape, split yarns, composite fibers, blow bottles, shopping bags, garbage bags, compost bags, fishing lines, cutlery, cosmetic containers, detergent containers, bleach containers, ropes, binding materials, sanitary cover stock materials, cold reserving boxes, cushioning material films, multifilaments, synthetic paper, surgical treads for medical use, sutures, artificial bones, artificial skin, microcapsules, wound covering material, and the like.

### EXAMPLES

Hereinafter, the present invention will be described in detail with reference to examples and comparative examples.

Further, the present invention is not limited to the following examples.

In the examples of the present application, the acid values and the hydroxyl values are values evaluated by the following methods.

### [Method of Measuring Acid Value]

The acid values were measured by the method in conformity with JIS K 0070-1992.

### [Method of Measuring Hydroxyl Value]

The hydroxyl values were measured by the method in conformity with JIS K 0070-1992.

In the examples of the present application, the number average molecular weight of polyester is a value in terms of polyester based on GPC measurement, and the measurement conditions are as follows.

### [GPC Measurement Conditions]

Measuring device: high-speed GPC device “HLC-8320GPC” (manufactured by Tosoh Corporation)

Columns: “TSK GUARD COLUMN SuperHZ-L” (manufactured by Tosoh Corporation)+“TSK gel SuperHZM-M” (manufactured by Tosoh Corporation)+“TSK gel SuperHZM-M” (manufactured by Tosoh Corporation)+“TSK gel SuperHZ-2000” (manufactured by Tosoh Corporation)+“TSK gel SuperHZ-2000” (manufactured by Tosoh Corporation)

Detector: refractive index (RI) detector

Deta processing: “EcoSEC Data Analysis Version 1.07” (manufactured by Tosoh Corporation) Column temperature: 40° C.

Developing solvent: tetrahydrofuran

Flow rate: 0.35 mL/min

Measurement sample: A measurement sample was obtained by dissolving 7.5 mg of a sample in 10 ml of tetrahydrofuran and filtering the obtained solution through a microfilter.

Sample injection volume: 20 μl

Standard sample: The following monodisperse polystyrene having a known molecular weight was used in conformity with the measurement manual of “HLC-8320GPC” described above.

### (Monodisperse Polystyrene)

“A-300” (manufactured by Tosoh Corporation)
“A-500” (manufactured by Tosoh Corporation)
“A-1000” (manufactured by Tosoh Corporation)
“A-2500” (manufactured by Tosoh Corporation)
“A-5000” (manufactured by Tosoh Corporation)
“F-1” (manufactured by Tosoh Corporation)
“F-2” (manufactured by Tosoh Corporation)
“F-4” (manufactured by Tosoh Corporation)
“F-10” (manufactured by Tosoh Corporation)
“F-20” (manufactured by Tosoh Corporation)
“F-40” (manufactured by Tosoh Corporation)
“F-80” (manufactured by Tosoh Corporation)
“F-128” (manufactured by Tosoh Corporation)
“F-288” (manufactured by Tosoh Corporation)

### Synthesis Example 1: Synthesis of Alkoxy Ether Diester (A1)

A 1 L four-necked flask was charged with 234 g of adipic acid, 461 g of 2-(2-methoxyethoxy)ethanol, and 0.04 g of tetraisopropyl titanate (hereinafter, abbreviated as “TiPT”) as a catalyst, and the mixture was heated to 210° C. and allowed to react for 14 hours. After the reaction, unreacted glycol was distilled off at 200° C. under reduced pressure. After the outflow of the unreacted glycol disappeared, the reduced pressure was released, the temperature was lowered, and the reaction product was filtered and taken out, thereby obtaining alkoxy ether diester (A1) in a transparent yellow liquid state.

The number average molecular weight of the obtained alkoxy ether diester (A1) was 390, the acid value thereof was 1.0, and the hydroxyl value thereof was 0.5.

### Synthesis Example 2: Synthesis of Alkoxy Ether Diester (A2)

A 1 L four-necked flask was charged with 159 g of succinic acid, 497 g of 2-(2-(2-methoxyethoxy)ethoxy)ethanol, and 0.02 g of TiPT as a catalyst, and the mixture was heated to 220° C. and allowed to react for 17 hours. After the reaction, unreacted glycol was distilled off at 200° C. under reduced pressure. After the outflow of the unreacted glycol disappeared, the reduced pressure was released, the temperature was lowered, and the reaction product was filtered and taken out, thereby obtaining alkoxy ether diester (A2) in a transparent yellow liquid state.

The number average molecular weight of the obtained alkoxy ether diester (A2) was 430, the acid value thereof was 0.6, and the hydroxyl value thereof was 1.3.

### Synthesis Example 3: Synthesis of Benzoic Acid Diester (B1)

A 2 L four-necked flask was charged with 979 g of benzoic acid (hereinafter, abbreviated as “BzA”), 159 g of propylene glycol (hereinafter, abbreviated as “PG”), 289 g of diethylene glycol, and 0.43 g of TiPT as a catalyst, and the mixture was heated to 230° C. and allowed to react for 11 hours. After the reaction, unreacted glycol was distilled off at 230° C. under reduced pressure. After the outflow of the unreacted glycol disappeared, the reduced pressure was released, the temperature was lowered, and the reaction product was filtered and taken out, thereby obtaining benzoic acid diester (B1) in a transparent yellow liquid state.

The number average molecular weight of the obtained benzoic acid diester (B1) was 310, the acid value thereof was 0.1, and the hydroxyl value thereof was 4.

### Synthesis Example 4: Synthesis of Benzoic Acid Diester (B2)

A 2 L four-necked flask was charged with 772 g of BzA, 229 g of diethylene glycol, 177 g of dipropylene glycol, and 0.35 g of TiPT as a catalyst, and the mixture was heated to 240° C. and allowed to react for 11 hours. After the reaction, unreacted glycol was distilled off at 210° C. under reduced pressure. After the outflow of the unreacted glycol disappeared, the reduced pressure was released, the temperature was lowered, and the reaction product was filtered and taken out, thereby obtaining benzoic acid diester (B2) in a transparent yellow liquid state.

The number average molecular weight of the obtained benzoic acid diester (B2) was 370, the acid value thereof was 0.1, and the hydroxyl value thereof was 5.

### Synthesis Example 5: Synthesis of Benzoic Acid Diester (B3)

A 3 L four-necked flask was charged with 1832 g of BzA, 461 g of glycerin, and 0.069 g of TiPT as a catalyst, and the mixture was heated to 220° C. and allowed to react for 20 hours. After the reaction, unreacted glycerin was distilled off at 220° C. under reduced pressure. After the outflow of the unreacted glycerin disappeared, the reduced pressure was released, the temperature was lowered, and the reaction product was filtered and taken out, thereby obtaining benzoic acid triester (B3) in a transparent yellow liquid state.

The number average molecular weight of the obtained benzoic acid triester (B3) was 410, the acid value thereof was 0.3, and the hydroxyl value thereof was 27.

### Example 1: Production and Evaluation of Cellulose Ester Optical Film

70 parts by mass of a cellulose acetate resin (acetylation degree of 2.36, acetification degree of 54.2%), 30 parts by mass of a plasticizer composition (a mixture of diester (A1) and diester (B2) in which the mass ratio of the diester (A1) to the diester (B2) (diester (A1):diester (B2)) was 8:2), and 0.1% by mass of IRGANOX-1010 as a stabilizer with respect to the amount of the cellulose acetate resin were blended with each other, stirred, and mixed at 70° C., thereby preparing a cellulose acetate resin composition.

The obtained composition was kneaded by using a small melt-kneading device (Labo-plastomill) to produce a press plate having a thickness of 3 mm and a size of 60 mm square using a hot press machine. The produced press plate was evaluated as follows. The results are listed in Table 1.

### (1) Transparency

The surface of the press plate was visually confirmed, and the transparency of the press plate was evaluated according to the following criteria.

Turbidity and foreign matter were not confirmed on the surface of the press plate: 0

Turbidity and/or foreign matter were confirmed on the surface of the press plate: X

(2) Compatibility after Wet Heat Test

The press plate was exposed to an environment of 85° C. and a relative humidity of 90% (wet heat environment), the state of the press plate after the wet heat test was visually confirmed, and the compatibility of the plasticizer was evaluated according to the following criteria.

Bleed-out of foreign matter was not confirmed on the surface of the press plate: 0

Bleed-out of foreign matter was confirmed on the surface of the press plate: X

### (3) Water Absorbency

While the press plate was exposed to an environment of 85° C. and a relative humidity of 90% (wet heat environment) for 24 hours, the mass of the press plate 6 hours after the start of the test and the mass of the press plate 24 hours after the start of the test (at the end of the test) were respectively measured. “(Mass of press plate after 24 hours−mass of press plate after 6 hours)/mass of press plate 6 hours after wet heat test” was calculated to evaluate a rate of an increase in the press plate during the wet heat test. It is preferable that the value thereof decrease from the viewpoint that the press plate is unlikely to be deformed due to moisture absorption.

The cellulose acetate resin composition used to produce the press plate was separately evaluated as follows. The results are listed in Table 1.

### (4) Amount of Acetic Acid Generated

The amount of acetic acid generated was investigated using a detecting tube (Kitagawa type gas detecting tube for acetic acid) by placing 1.000 g of the composition used to produce the press plate in a 25 ml sample bottle, allowing the composition to stand under conditions of 85° C. and a humidity of 90% for one day without a lid of the sample bottle, and allowing the composition to further stand for 168 hours with a lid of the sample bottle. As the amount of acetic acid generated decreases, the plasticizer in the composition is unlikely to be hydrolyzed, and degradation of the durability of the molded article obtained can be suppressed.

### Examples 2 to 4 and Comparative Example 1 to 5: Production and Evaluation of Cellulose Ester Optical Film

Cellulose acetate resin compositions were prepared and press plates were produced in the same manner as in Example 1 except that the plasticizer was changed as in Table 1, and the evaluations were performed in the same manner as in Example 1. The results are listed in Table 1.

TABLE 1

| | | | | | Amount of |
|---|---|---|---|---|---|
| | | | | Water | acetic acid |
| | | | | absorbency | generated |
| | Plasticizer | Transparency | Compatibility | [mass %] | [mass ppm] |
| Example 1 | A1/B2 = 8/2 (mass ratio) | ∘ | ∘ | 5% | 25 |
| Example 2 | A2/B1 = 5/5 (mass ratio) | ∘ | ∘ | 4% | 25 |
| Example 3 | A2/B1 = 7/3 (mass ratio) | ∘ | ∘ | 4% | 28 |
| Example 4 | A2/B3 = 7/3 (mass ratio) | ∘ | ∘ | 5% | 35 |
| Comparative | A1 | ∘ | ∘ | 5% | 42 |
| Example 1 | | | | | |
| Comparative | A2 | ∘ | ∘ | 6% | 125 |
| Example 2 | | | | | |
| Comparative | B1 | ∘ | x | 3% | 6 |
| Example 3 | | | | | |
| Comparative | B2 | ∘ | x | 3% | 6 |
| Example 4 | | | | | |
| Comparative | B3 | x | ∘ | 3% | 6 |
| Example 5 | | | | | |

As shown in the results of the amount of acetic acid generated in Example 1 and Comparative Example 1, and Examples 2 to 4 and Comparative Example 2 listed in Table 1, it can be seen that hydrolysis of the alkoxy ether diester can be suppressed by using the benzoic acid ester compound in combination with the alkoxy ether diester.

1. A plasticizer composition for a cellulose ester resin, comprising:
an alkoxy ether diester compound represented by General Formula (A); and
a benzoic acid ester compound represented by General Formula (B), 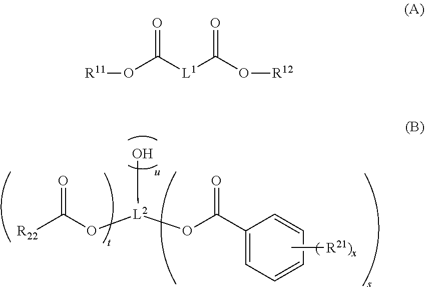
in General Formulae (A) and (B),
L¹ represents an alkylene group having 1 to 18 carbon atoms,
R¹¹ and R¹² each independently represent an alkyl group having an ether bond with 2 to 24 carbon atoms,
R²¹ represents an alkyl group having 1 to 6 carbon atoms,
L² represents a divalent aliphatic group or a trivalent aliphatic group,
R²² represents an alkyl group having 1 to 20 carbon atoms or an alkyl group having an ether bond with 2 to 20 carbon atoms,
s represents an integer of 1 to 3, t represents an integer of O to 2, u represents an integer of O to 2, and a sum of s, t, and u is an integer corresponding to the valence of the aliphatic group as L2, and
x represents an integer of O to 5.

2. The plasticizer composition for a cellulose ester resin according to Claim 1,
wherein a mass ratio of the alkoxy ether diester compound to the benzoic acid ester compound (alkoxy ether diester compound:benzoic acid ester compound) is in a range of 85:15 to 40:60.

3. The plasticizer composition for a cellulose ester resin according to claim 1,
wherein the alkoxy ether diester compound is an alkoxy ether diester compound represented by General Formula (A1), 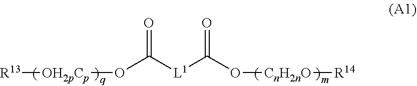
in General Formula (A1),
L¹ represents an alkylene group having 1 to 18 carbon atoms,
n represents an integer of 1 to 4,
m represents an integer of 2 to 4,
p represents an integer of 1 to 4,
q represents an integer of 2 to 4,
R¹³ and R¹⁴ each independently represent an alkyl group having 1 to 6 carbon atoms,
m number of n's may be the same as or different from each other, and q number of p's may be the same as or different from each other.

4. The plasticizer composition for a cellulose ester resin according to claim 1,
wherein L¹ represents a malonic acid residue, a succinic acid residue, a glutaric acid residue, an adipic acid residue, a pimelic acid residue, a suberic acid residue, an azelaic acid residue, a sebacic acid residue, a dodecanedicarboxylic acid residue, a maleic acid residue, a fumaric acid residue, a 1,2-dicarboxycyclohexane residue, or a 1,2-dicarboxycyclohexene residue.

5. The plasticizer composition for a cellulose ester resin according to claim 1,
wherein R¹¹ and R¹² each independently represent an alcohol residue of polyalkylene glycol monoalkyl ether selected from diethylene glycol monomethyl ether, diethylene glycol monoethyl ether, triethylene glycol monomethyl ether, triethylene glycol monoethyl ether, tetraethylene glycol monomethyl ether, and tetraethylene glycol monoethyl ether.

6. The plasticizer composition for a cellulose ester resin according to claim 1,
wherein the benzoic acid ester compound is a benzoic acid ester compound represented by General Formula (B1), 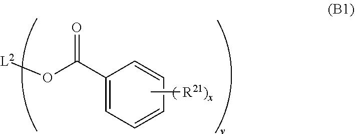
in General Formula (B1),
L² represents a divalent aliphatic group or a trivalent aliphatic group,
v represents an integer corresponding to the valence of the aliphatic group as L²,
R²¹ represents an alkyl group having 1 to 6 carbon atoms, and
x represents an integer of 0 to 5.

7. The plasticizer composition for a cellulose ester resin according to claim 1,
wherein L² represents an ethylene glycol residue, a 1,2-propylene glycol residue, a 1,3-propanediol residue, a 1,2-butanediol residue, a 1,3-butanediol residue, a 2-methyl-1,3-propanediol residue, a neopentyl glycol residue, a diethylene glycol residue, a dipropylene glycol residue, a triethylene glycol residue, a tripropylene glycol residue, a trimethylolpropane residue, or a glycerin residue.

8. A cellulose ester resin composition comprising:
the plasticizer composition for a cellulose ester resin according to claim 1; and
a cellulose ester resin,
wherein a content of the plasticizer composition for a cellulose ester resin is in a range of 1 to 100 parts by mass with respect to 100 parts by mass of the cellulose ester resin.

9. A molded article of the cellulose ester resin composition according to claim 8.

10. The molded article according to claim 9,
wherein the molded article is an eyeglass frame.

11. The plasticizer composition for a cellulose ester resin according to claim 2,
wherein the alkoxy ether diester compound is an alkoxy ether diester compound represented by General Formula (A1), 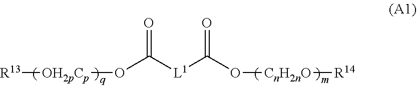
in General Formula (A1),
L¹ represents an alkylene group having 1 to 18 carbon atoms,
n represents an integer of 1 to 4,
m represents an integer of 2 to 4,
p represents an integer of 1 to 4,
q represents an integer of 2 to 4,
R¹³ and R¹⁴ each independently represent an alkyl group having 1 to 6 carbon atoms,
m number of n's may be the same as or different from each other, and q number of p's may be the same as or different from each other.

12. The plasticizer composition for a cellulose ester resin according to claim 2,
wherein L¹ represents a malonic acid residue, a succinic acid residue, a glutaric acid residue, an adipic acid residue, a pimelic acid residue, a suberic acid residue, an azelaic acid residue, a sebacic acid residue, a dodecanedicarboxylic acid residue, a maleic acid residue, a fumaric acid residue, a 1,2-dicarboxycyclohexane residue, or a 1,2-dicarboxycyclohexene residue.

13. The plasticizer composition for a cellulose ester resin according to claim 2,
wherein R¹¹ and R¹² each independently represent an alcohol residue of polyalkylene glycol monoalkyl ether selected from diethylene glycol monomethyl ether, diethylene glycol monoethyl ether, triethylene glycol monomethyl ether, triethylene glycol monoethyl ether, tetraethylene glycol monomethyl ether, and tetraethylene glycol monoethyl ether.

14. The plasticizer composition for a cellulose ester resin according to claim 2,
wherein the benzoic acid ester compound is a benzoic acid ester compound represented by General Formula (B1), 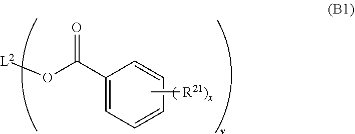
in General Formula (B1),
L² represents a divalent aliphatic group or a trivalent aliphatic group,
v represents an integer corresponding to the valence of the aliphatic group as L²,
R²¹ represents an alkyl group having 1 to 6 carbon atoms, and
x represents an integer of 0 to 5.

15. The plasticizer composition for a cellulose ester resin according to claim 2,
wherein L² represents an ethylene glycol residue, a 1,2-propylene glycol residue, a 1,3-propanediol residue, a 1,2-butanediol residue, a 1,3-butanediol residue, a 2-methyl-1,3-propanediol residue, a neopentyl glycol residue, a diethylene glycol residue, a dipropylene glycol residue, a triethylene glycol residue, a tripropylene glycol residue, a trimethylolpropane residue, or a glycerin residue.

16. A cellulose ester resin composition comprising:
the plasticizer composition for a cellulose ester resin according to claim 2; and
a cellulose ester resin,
wherein a content of the plasticizer composition for a cellulose ester resin is in a range of 1 to 100 parts by mass with respect to 100 parts by mass of the cellulose ester resin.

17. A molded article of the cellulose ester resin composition according to claim 16.

18. The molded article according to claim 17,
wherein the molded article is an eyeglass frame.
